(19) United States
(12) Patent Application Publication
(10) Pub. No.: US 2013/0201555 A1
(43) Pub. Date: Aug. 8, 2013

(54) SYSTEM, METHOD, AND COMPUTER PROGRAM PRODUCT FOR ADJUSTING A LENS POLARIZATION

(71) Applicant: David R. Cook, San Jose, CA (US)

(72) Inventor: David R. Cook, San Jose, CA (US)

(73) Assignee: NVIDIA CORPORATION, Santa Clara, CA (US)

(21) Appl. No.: 13/368,251

(22) Filed: Feb. 7, 2012

(51) Int. Cl. G02B 27/26

(52) U.S. Cl. 359/465

(57) ABSTRACT

A system, method, and computer program product are provided for adjusting a lens polarization. In use, one or more characteristics associated with a display are identified. Additionally, a polarization of one or more lenses is adjusted, based on the one or more characteristics.

### FIELD OF THE INVENTION

The present invention relates to stereo viewing, and more particularly to lens polarization.

### BACKGROUND

Stereo viewing has become a mainstream means for users to view different types of media. For example, stereo viewing may be used to view pictures and movies, play video games, etc. However, current techniques for implementing stereo viewing have been associated with various limitations.

For example, a user that views a display with a particular polarization using lenses having the same fixed polarization as the display may not be able to properly view a display with a different polarization, as the polarization of the display may not be synchronized with the fixed polarization of the lenses.

There is thus a need for addressing these and/or other issues associated with the prior art.

### SUMMARY

A system, method, and computer program product are provided for adjusting a lens polarization. In use, one or more characteristics associated with a display are identified. Additionally, a polarization of one or more lenses is adjusted, based on the one or more characteristics.

### BRIEF DESCRIPTION OF THE DRAWINGS

FIG. 1 shows a method for adjusting a lens polarization, in accordance with one embodiment.

FIG. 2 shows an exemplary stereo viewing system, in accordance with another embodiment.

FIG. 3 shows a stereo viewing system before a polarization adjustment, in accordance with yet another embodiment.

FIG. 4 shows a stereo viewing system after a polarization adjustment, in accordance with yet another embodiment.

FIG. 5 illustrates an exemplary system in which the various architecture and/or functionality of the various previous embodiments may be implemented.

### DETAILED DESCRIPTION

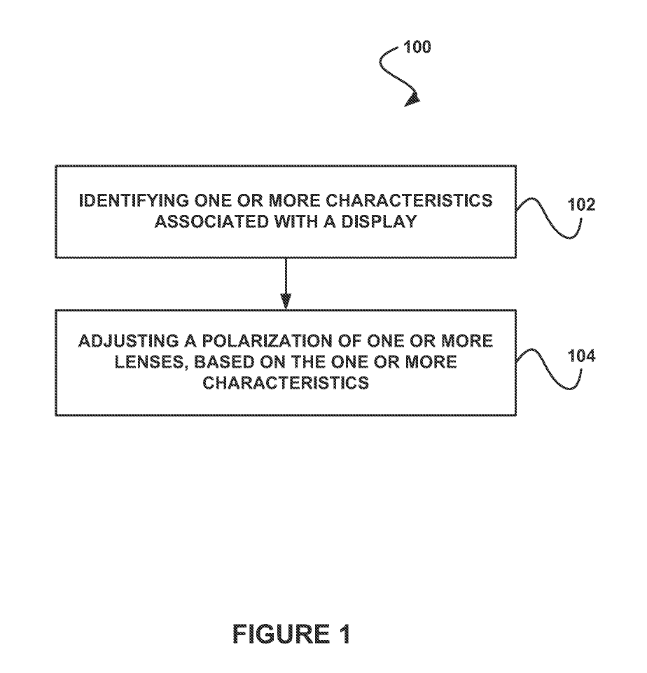

FIG. 1 shows a method 100 for adjusting a lens polarization, in accordance with one embodiment. As shown in operation 102, one or more characteristics associated with a display are identified. In one embodiment, the display may include a computer monitor. In another embodiment, the display may include a television screen. In yet another embodiment, the display may include a liquid crystal display (LCD), a thin film transistor (TFT) LCD, a plasma display, a light emitting diode (LED) display, etc. Of course, however, the display may include any device capable of displaying one or more images. In another embodiment, the display may be viewed using one or more lenses. For example, the display may be viewed using a pair of polarized lenses, where each lens of the pair of lenses is associated with an eye of a viewer of the display, such that each lens is worn over (and therefore covers) the associated eye. In yet another embodiment, the one or more lenses may be included within a pair of viewing glasses used for viewing the display. In still another embodiment, the lenses may be polarized using linear polarization.

Additionally, in one embodiment, the one or more characteristics may include one or more polarizations associated with a display. For example, the one or more characteristics may include a polarization used by the display during a presentation of one or more images by the display. In another embodiment, the one or more polarizations may include a polarization used by the display to present images for viewing by a particular eye of a viewer of the display. For example, the polarization may include a polarization used by the display to present images for viewing by a left eye of a viewer and a polarization used by the display to present images for viewing by a right eye of a viewer.

Further, in one embodiment, the one or more characteristics may include an amount of light (e.g., an amount of light produced by the display, etc.) that is viewable by a viewer of the display. For example, the one or more characteristics may include an amount of light from the display that is viewable by an eye of the viewer of the display. In another embodiment, the one or more characteristics may include an amount of light from the display that is viewable through one or more lenses. For example, the one or more characteristics may include an amount of light produced by the display that is viewable by an eye of the viewer of the display through a lens covering the eye of the viewer (e.g., a lens worn by the viewer, etc.).

Further still, in one embodiment, the one or more characteristics may be identified utilizing a database. For example, one or more polarizations associated with the display may be stored in the database, and the database may be queried by the pair of viewing glasses used for viewing the display (e.g., using one or more wireless methods, etc.) or by a computer associated with the viewing glasses (e.g., connected to the viewing glasses, etc.). in another embodiment, the one or more characteristics may be input by a user. For example, the user may input a polarization associated with the display into the pair of viewing glasses used for viewing the display (e.g., using one or more interfaces, etc.) or into the computer associated with the viewing glasses.

Also, in one embodiment, the one or more characteristics may be identified utilizing one or more sensors (e.g., one or more optical sensors, light sensors, etc.). For example, the one or more characteristics may be identified utilizing one or more sensors located behind the one or more lenses (e.g., where the one or more lenses are situated between the one or more sensors and the display). In another embodiment, the one or more sensors may detect an amount of light produced by the display that is viewable through the one or more lenses. In another embodiment, a single sensor may be placed behind one lens of a pair of polarized lenses. in yet another embodiment, a sensor may be placed behind each lens of the pair of polarized lenses. In this way, the one or more sensors may detect an amount of light produced by the display that is viewable by a viewer of the display.

In addition, as shown in operation 104, a polarization of one or more lenses is adjusted, based on the one or more characteristics. In one embodiment, the one or more lenses may include the lenses of the pair of viewing glasses through which the display is viewed. In another embodiment, the one or more lenses may have a predetermined polarization. For example, the one or more lenses may have a default polarization, a polarization intended for use with a particular display, etc. In yet another embodiment, the polarization of one lens of the pair of viewing glasses may be different from the polarization of the other lens of the viewing glasses. For example, there may be a 90 degree difference between the polarization of each of the lenses. In still another embodiment, the polarization of one lens of the pair of viewing glasses may be the same as the polarization of the other lens of the viewing glasses, which may enable a monoscopic view of the display.

Further, in one embodiment, the polarization of the one or more lenses may be provided by a voltage being applied (e.g., sent, etc.) to the one or more lenses, and may be adjusted by altering a voltage being applied to the one or more lenses. For example, a voltage may be applied to each of the one or more lenses in order to provide each of the lenses with a particular polarization, and the voltage applied to each of the lenses may be altered, such that each of the one or more lenses may have an adjustable polarization. In another embodiment, the polarization of the one or more lenses may be adjusted utilizing a processor. For example, a microprocessor may control the voltage being applied to the one or more lenses.

Further still, in one embodiment, the voltage sent to the one or more lenses may be altered according to the identified polarization associated with the display. For example, the voltage sent to a left lens covering a left eye of a viewer may be altered such that the polarization of the left lens is the same as an identified polarization used by the display to present images for viewing by a left eye of a viewer. In another example, the voltage sent to a right lens covering a right eye of a viewer may be altered such that the polarization of the right lens is the same as an identified polarization used by the display to present images for viewing by a right eye of a viewer.

In another embodiment, the voltage sent to a left lens covering a left eye of a viewer and the voltage sent to a right lens covering a right eye of a viewer may both be altered such that both the polarization of the left lens and the right lens is the same as an identified polarization used by the display to present images for viewing by a left eye of a viewer. In still another embodiment, the voltage sent to the left lens and the voltage sent to the right lens may both be altered such that both the polarization of the left lens and the right lens is the same as an identified polarization used by the display to present images for viewing by a right eye of a viewer. In this way, a unique mono-scopic view of the display may be provided to a viewer.

Also, in one embodiment, the voltage sent to the one or more lenses may be altered according to the identified amount of light that is viewable by the viewer of the display through the one or more lenses. For example, the voltage sent to a lens covering an eye of a viewer may be altered such that the amount of light viewable by one or more sensors situated behind the lens (e.g., where the lens is situated between the sensor and the display) is increased.

In another example, the voltage sent to a left lens covering a left eye of a viewer may be altered such that the amount of light viewable by one or more sensors situated behind the left lens (e.g., where the lens is situated between the sensor and the display) is increased. Additionally, the voltage sent to a right lens covering a right eye of the viewer may be altered such that the amount of light viewable by one or more sensors situated behind the right lens is increased.

Additionally, in one embodiment, the voltage sent to a lens covering an eye of a viewer may be altered such that the amount of light viewable by one or more sensors situated behind the lens is increased to a point where the amount of light viewable by one or more sensors situated behind the lens cannot be increased further. In this way, the voltage may be altered to a point where the amount of light viewable by one or more sensors situated behind the lens is maximized.

Further, in one embodiment, the one or more lenses may include a pair of polarized lenses, and the polarization of one lens of the pair may be adjusted according to the polarization of the other lens of the pair. For example, the voltage sent to a left lens covering a left eye of a viewer may be altered such that the polarization of the left lens is the same as an identified polarization used by the display to present images for viewing by a left eye of a viewer, or such that the amount of light viewable by one or more sensors situated behind the left lens is increased. In another example, the voltage sent to a right lens covering a right eye of a viewer may be altered such that the polarization of the right lens differs by 90 degrees from the polarization of the left lens,

In yet another example, the voltage sent to a right lens covering a right eye of a viewer may be altered such that the polarization of the right lens is the same as an identified polarization used by the display to present images for viewing by a right eye of a viewer, or such that the amount of light viewable by one or more sensors situated behind the right lens is increased. In another example, the voltage sent to a left lens covering a left eye of a viewer may be altered such that the polarization of the left lens differs by 90 degrees from the polarization of the right lens.

Further still, in one embodiment, the polarization of one or more lenses may be adjusted automatically in real time, based on the one or more characteristics. In this way, a brightness of the display (e.g., an amount of light produced by the display) that is perceived by the user through the one or more lenses may be maximized. Additionally, display ghosting (e.g., offset replicas of images transmitted by the display, etc.) may be reduced.

More illustrative information will now be set forth regarding various optional architectures and features with which the foregoing framework may or may not be implemented, per the desires of the user. It should be strongly noted that the following information is set forth for illustrative purposes and should not be construed as limiting in any manner. Any of the following features may be optionally incorporated with or without the exclusion of other features described.

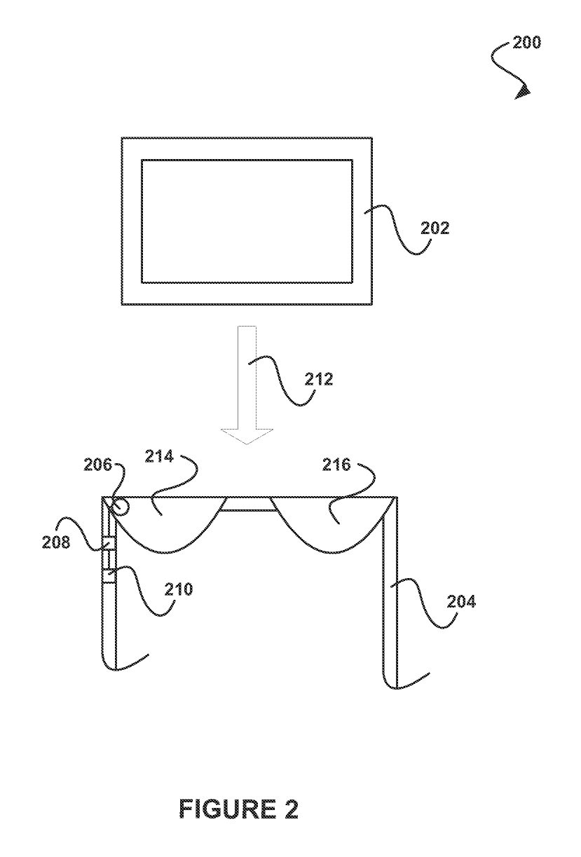

FIG. 2 shows an exemplary stereo viewing system 200, in accordance with another embodiment. As an option, the system 200 may be carried out in the context of the functionality of FIG. 1. Of course, however, the system 200 may be implemented in any desired environment. It should also be noted that the aforementioned definitions may apply during the present description.

As shown, the stereo viewing system 200 includes a display 202 and a pair of stereo viewing glasses 204. Additionally, the stereo viewing glasses 204 include a light sensor 206, a microprocessor 208, and a power supply 210, as well as a polarized left lens 214 and a right polarized lens 216, where polarized left lens 214 is located between the sensor 206 and the display 202. In one embodiment, light 212 that is produced by the display 202 may pass through the left lens 214 of the stereo viewing glasses 204 and may be detected and measured by the sensor 206 of the stereo viewing glasses 204. In another embodiment, the light 212 produced by the display 202 may include light from images meant for the polarized left lens 214 of the stereo viewing glasses 204.

Additionally, in one embodiment, the measurement of the amount of light viewable by the sensor 206 through the left lens 214 may be sent to the microprocessor 208. In another embodiment, the microprocessor 208 may determine whether an alteration of the polarization of the left lens 214 is necessary, based on the measured amount of light from the sensor 206. For example, the microprocessor 208 may compare the measured amount of light to a threshold, and if the measured amount of light is under the threshold, then the microprocessor 208 may determine that an alteration of the polarization of the left lens 214 is necessary.

In another example, the microprocessor 208 may compare the measured amount of light to one or more previously measured amounts of light (e.g., amounts of light viewable by the sensor 206 through the left lens 214 when the left lens 214 had different polarizations), and if the measured amount of light is less than the largest amount of the previously measured amounts of light, then the microprocessor 208 may determine that an alteration of the polarization of the left lens 214 (e.g., an alteration to the different polarization that yielded the previously measured largest amount of light) is necessary.

Further, in one embodiment, if it is determined by the microprocessor 208 that an alteration of the polarization of the left lens 214 is necessary, then the microprocessor 208 may alter the polarization of the lens 214, utilizing the power supply 210. For example, the microprocessor 208 may alter (e.g., raise, lower, etc.) a voltage sent to the left lens 214 by the power supply 210, in order to alter the polarization of the lens 214.

In another embodiment, the microprocessor 208 may incrementally alter the polarization of the left lens 214 (e.g., by a fraction of a degree, by a degree, etc.) and may determine an amount of the light 212 produced by the display 202 that is detected through the left lens 214 by the sensor 206 at each incremental polarization. Additionally, the microprocessor 208 may then determine an optimal polarization of the lens 214. For example, the microprocessor 208 may determine a polarization of the left lens 214 during the incremental alteration of the polarization of the left lens 214 at which the amount of light detected through the left lens 214 by the sensor 206 is the greatest (e.g., when compared to the amount of detected light at all incremental polarization amounts for the lens 214). In response to the determination, the microprocessor 208 may then set the polarization of the left lens 214 as the optimal polarization of the lens 214. In this way, the amount of light 212 produced by the display 202 that is viewable through the left lens 214 may be maximized.

Further still, in one embodiment, an alteration of the polarization of the right lens 216 may also be performed. For example, the microprocessor 208 may alter the polarization of the right lens 216 to have a polarization that is adjusted 90 degrees from the left lens 214. In another example, a separate sensor may be located behind the right lens 216, and the microprocessor 208 (or a different microprocessor) may determine whether an alteration of the polarization of the right lens 216 is necessary, using one or more of the above methods, where the light 212 produced by the display 202 may include light from images meant for the polarized right lens 216 of the stereo viewing glasses 204. In this way, both the left lens 214 and the right lens 216 may be altered for optimized stereo viewing of the display 202.

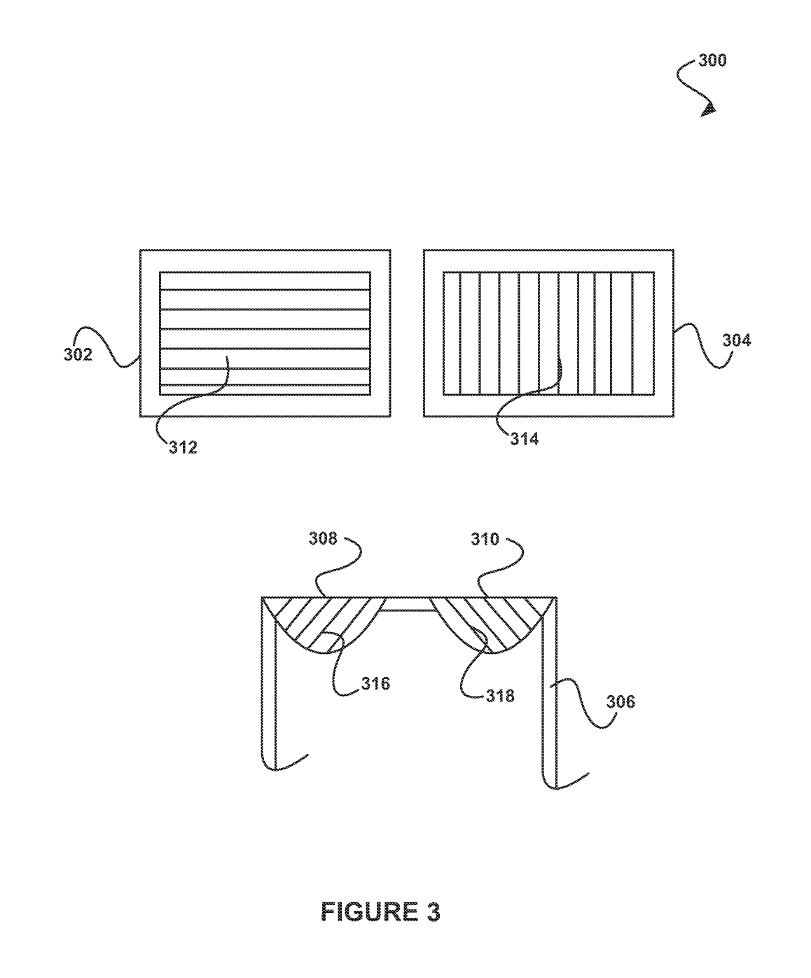

FIG. 3 shows a stereo viewing system 300 before a polarization adjustment, in accordance with another embodiment. As an option, the present system 300 may be carried out in the context of the functionality of FIGS. 1 and 2. Of course, however, the system 300 may be implemented in any desired environment. It should also be noted that the aforementioned definitions may apply during the present description.

As shown, the system 300 includes a left eye view 302 and a right eye view 304 of a display, as well as a pair of stereo viewing glasses 306 with a left lens 308 and a right lens 310. In one embodiment, the left eye view 302 of the display may include images produced by light from the display that are meant for viewing by a left eye of a viewer. Additionally, the right eye view 304 of the display may include images produced by light from the display that are meant for viewing by a right eye of a viewer,

Further, in one embodiment, the left lens 308 of the stereo viewing glasses 306 may include a lens meant for covering a left eye of the user. In another embodiment, the right lens 308 of the stereo viewing glasses 306 may include a lens meant for covering a right eye of the user. Further still, the left eye view 302 of the display includes a first polarization 312, and the right eye view 304 of the display includes a second polarization 314. In one embodiment, the first polarization 312 may differ from the second polarization 314 by 90 degrees.

Also, the left lens 308 of the stereo viewing glasses 306 includes a third polarization 316, and the right lens 310 of the stereo viewing glasses 306 includes a fourth polarization 318, where the third polarization 316 does not match the first polarization 312, and where the fourth polarization 318 does not match the second polarization 314. In one embodiment, the third polarization 316 may not match the first polarization 312 and the fourth polarization 318 may not match the second polarization 314 due to one or more factors.

For example, the polarizations may not match due to the fact that the display that produces the left eye view 302 and the right eye view 304 has not previously been used or calibrated with the stereo viewing glasses 306. In another example, the polarizations may not match due to the fact that the display that produces the left eye view 302 and the right eye view 304 has been tilted at an angle with respect to the stereo viewing glasses 306 (e.g., the display has been tilted from landscape to portrait mode, etc.). In yet another example, the polarizations may not match due to the fact that a viewer wearing the stereo viewing glasses 306 tilts their head to either side with respect to the display producing the left eye view 302 and the right eye view 304 (e.g., while viewing the display, etc.).

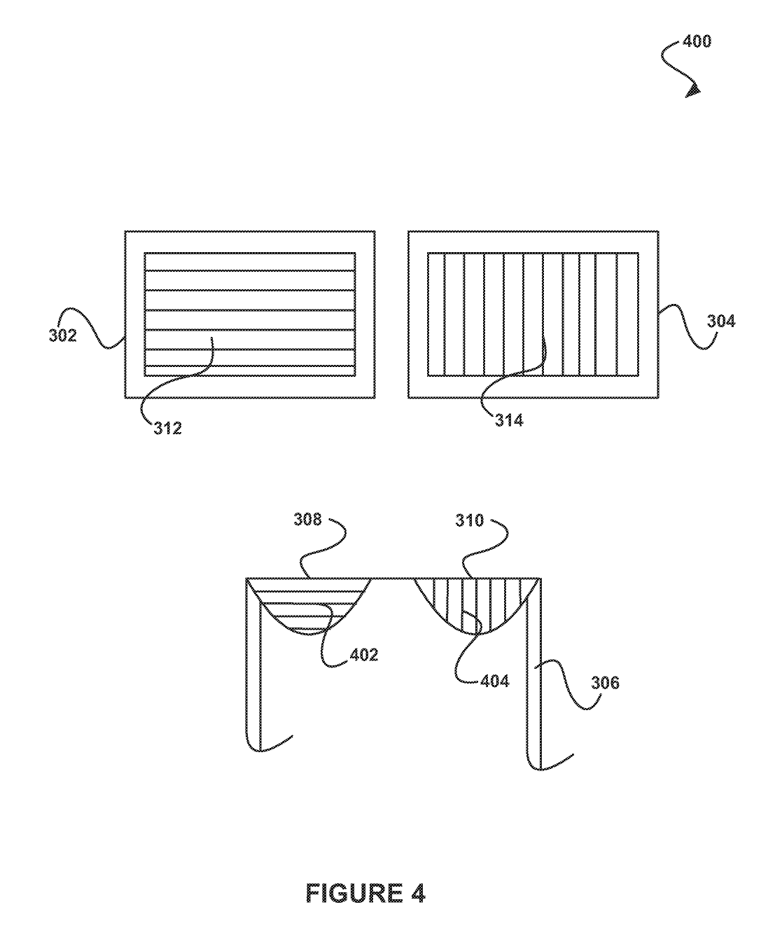

FIG. 4 shows a stereo viewing system 400 after a polarization adjustment, in accordance with another embodiment. As an option, the present system 400 may be carried out in the context of the functionality of FIGS. 1-3. Of course, however, the system 400 may be implemented in any desired environment. It should also be noted that the aforementioned definitions may apply during the present description.

As shown, the left lens 308 of the stereo viewing glasses 306 has a first updated polarization 402, and the right lens 310 of the stereo viewing glasses 306 has a second updated polarization 404. In one embodiment, the first updated polarization 402 and the second updated polarization 404 may be created by a microprocessor located within the stereo viewing glasses 306. For example, the first updated polarization 402 and the second updated polarization 404 may be created by the microprocessor in response to an input polarization, an amount of light viewable by a sensor through one or both of the lenses 308 and 310, etc.

Additionally, the first updated polarization 402 of the left lens 308 is the same as the first polarization 312 of the left eye view 302 of the display, and the second updated polarization 404 of the right lens 310 is the same as the second polarization 314 of the right eye view 304 of the display. In this way, the images produced by the left eye view 302 of the display that are meant for viewing by a left eye of a viewer may be viewed by the left eye of the user through the left lens 308 of the stereo viewing glasses 306, and not through the right eye of the user through the right lens 310 of the stereo viewing glasses 306. Additionally, the images produced by the right eye view 304 of the display that are meant for viewing by a right eye of a viewer may be viewed by the right eye of the user through the right lens 310 of the stereo viewing glasses 306, and not through the left eye of the user through the left lens 308 of the stereo viewing glasses 306. Further, brightness may therefore be optimized, and ghosting may be reduced.

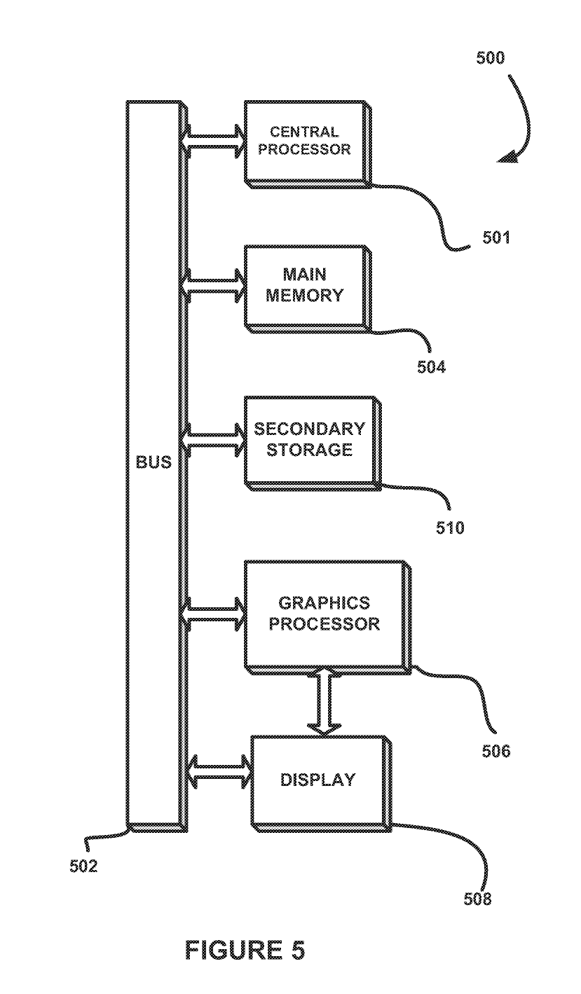

FIG. 5 illustrates an exemplary system 500 in which the various architecture and/or functionality of the various previous embodiments may be implemented. As shown, a system 500 is provided including at least one host processor 501 which is connected to a communication bus 502. The system 500 also includes a main memory 504. Control logic (software) and data are stored in the main memory 504 which may take the form of random access memory (RAM).

The system 500 also includes a graphics processor 506 and a display 508, i.e. a computer monitor. In one embodiment, the graphics processor 506 may include a plurality of shader modules, a rasterization module, etc. Each of the foregoing modules may even be situated on a single semiconductor platform to form a graphics processing unit (GPU).

In the present description, a single semiconductor platform may refer to a sole unitary semiconductor-based integrated circuit or chip. It should be noted that the term single semiconductor platform may also refer to multi-chip modules with increased connectivity which simulate on-chip operation, and make substantial improvements over utilizing a conventional central processing unit (CPU) and bus implementation. Of course, the various modules may also be situated separately or in various combinations of semiconductor platforms per the desires of the user.

The system 500 may also include a secondary storage 510. The secondary storage 510 includes, for example, a hard disk drive and/or a removable storage drive, representing a floppy disk drive, a magnetic tape drive, a compact disk drive, etc. The removable storage drive reads from and/or writes to a removable storage unit in a well known manner.

Computer programs, or computer control logic algorithms, may be stored in the main memory 504 and/or the secondary storage 510. Such computer programs, when executed, enable the system 500 to perform various functions. Memory 504, storage 510 and/or any other storage are possible examples of computer-readable media.

In one embodiment, the architecture and/or functionality of the various previous figures may be implemented in the context of the host processor 501, graphics processor 506, an integrated circuit (not shown) that is capable of at least a portion of the capabilities of both the host processor 501 and the graphics processor 506, a chipset (i.e. a group of integrated circuits designed to work and sold as a unit for performing related functions, etc.), and/or any other integrated circuit for that matter.

Still yet, the architecture and/or functionality of the various previous figures may be implemented in the context of a general computer system, a circuit board system, a game console system dedicated for entertainment purposes, an application-specific system, and/or any other desired system. For example, the system 500 may take the form of a desktop computer, lap-top computer, and/or any other type of logic. Still yet, the system 500 may take the form of various other devices in including, but not limited to a personal digital assistant (PDA) device, a mobile phone device, a television, etc.

Further, while not shown, the system 500 may be coupled to a network [e.g. a telecommunications network, local area network (LAN), wireless network, wide area network (WAN) such as the Internet, peer-to-peer network, cable network, etc.) for communication purposes.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method, comprising:
identifying one or more characteristics associated with a display; and
adjusting a polarization of one or more lenses, based on the one or more Characteristics.

2. The method of claim 1, wherein the one or more characteristics include one or more polarizations associated with a display.

3. The method of claim 2, wherein the one or more polarizations include a polarization used by the display to present images for viewing by a particular eye of a viewer of the display.

4. The method of claim 1, wherein the one or more characteristics include an amount of light produced by the display that is viewable by an eye of the viewer of the display through a lens covering the eye of a viewer.

5. The method of claim 1, wherein the one or more characteristics are identified utilizing one or more sensors.

6. The method of claim 1, wherein the one or more characteristics are identified utilizing one or more sensors located behind the one or more lenses.

7. The method of claim 6, wherein the one or more sensors detect an amount of light produced by the display that is viewable through the one or more lenses.

8. The method of claim 1, wherein a single sensor is placed behind one lens of a pair of polarized lenses.

9. The method of claim 1, wherein the one or more lenses include lenses of a pair of viewing glasses through which the display is viewed.

10. The method of claim 9, wherein a polarization of one lens of the pair of viewing glasses is different from a polarization of the other lens of the viewing glasses.

11. The method of claim 1, wherein the polarization of the one or more lenses is provided by a voltage being applied to the one or more lenses.

12. The method of claim 11, wherein the polarization of the one or more lenses is adjusted by altering the voltage being applied to the one or more lenses.

13. The method of claim 11, wherein, a microprocessor controls the voltage being applied to the one or more lenses.

14. The method of claim 12, wherein the voltage sent to the one or more lenses is altered according to an identified polarization associated with the display.

15. The method of claim 12, wherein the voltage sent to the one or more lenses is altered according to an identified amount of light that is viewable by the viewer of the display through the one or more lenses.

16. The method of claim 1, wherein the one or more lenses include a pair of polarized lenses, and a polarization of one lens of the pair is adjusted according to a polarization of another lens of the pair.

17. The method of claim 1, wherein the polarization of the one or more lenses is adjusted automatically in real time.

18. A computer program product embodied on a computer readable medium, comprising:
code for identifying one or more characteristics associated with a display; and
code for adjusting a polarization of one or more lenses, based on the one or more characteristics.

19. A system, comprising:
a display; and
a pair of viewing glasses for viewing the display, where the viewing glasses identify one or more characteristics associated with the display, and adjust a polarization of one or more lenses of the viewing glasses, based on the one or more characteristics.

20. The system of claim 19, wherein the viewing glasses include memory coupled to a processor via a bus.
